(19) United States
(12) Patent Application Publication
(10) Pub. No.: US 2018/0010678 A1
(43) Pub. Date: Jan. 11, 2018

(54) CAM-OPERATED DEVICE FOR CONTROLLING AT LEAST ONE COMPONENT

(71) Applicant: Valeo Systemes Thermiques, Le Mesnil Saint-Denis (FR)

(72) Inventor: Christian Dubois, Le Mesnil Saint Denis (FR)

(73) Assignee: Valeo Systemes Thermiques, Le Mesnil Saint-Denis (FR)

(21) Appl. No.: 15/544,976

(22) PCT Filed: Jan. 18, 2016
(86) PCT No.: PCT/EP2016/050853

§ 371 Date: Jul. 20, 2017

(30) Foreign Application Priority Data
Jan. 27, 2015 (FR) 1550626

(51) Int. Cl. F16H 53/08; F16H 25/18; B60H 1/00

(52) U.S. Cl. CPC F16H 53/08; B60H 1/00857; F16H 25/18

(57) ABSTRACT

The present invention relates to a cam-operated device (5) for controlling at least one component, said device comprising a cam (6) comprising at least one first camway (7, 8) on a first face and a second camway (9) on an opposite face, said first camway (7, 8) having a depth, measured starting from an opening, at the level of said first face, of said first camway, and said second camway (9) having a depth, measured starting from an opening, at the level of said opposite face, of said second camway, a height of the cam (6), measured between the opening of the first and second camways, being less than the sum of the depths of the camways (7, 8, 9).

The present invention relates to a cam-operated device for controlling at least one component, to a system for operating at least one movable part comprising said cam-operated device, and to a heating, ventilation and/or air-conditioning unit, in particular for motor vehicles, comprising such an operating system.

A motor vehicle is commonly equipped with an installation for the heat treatment of an air flow, also called heating, ventilation and/or air-conditioning installation, for modifying the aerothermic parameters of an air flow intended to be distributed inside a cabin of the vehicle. To this end, the heating, ventilation and/or air-conditioning installation comprises a heating, ventilation and/or air-conditioning unit intended to channel the air flow prior to its distribution inside the cabin. The heating, ventilation and/or air-conditioning unit is preferably housed below a dashboard of the vehicle arranged in the front part of the cabin of the vehicle. The heating, ventilation and/or air-conditioning unit generally comprises an air inlet housing and a heat treatment housing.

The heat treatment housing comprises various components for the heat treatment of an air flow, among which there can be distinguished, on the one hand, heat exchangers, such as an evaporator and/or a radiator, intended for the heat treatment of the air flow, in particular by allowing cooling thereof and/or dehumidifying thereof and/or heating thereof, and, on the other hand, aeraulic management means, such as a blower, making it possible to channel the air flow and to distribute it into various zones of the cabin.

The distribution means installed in the heat treatment housing distribute the air flow leaving a mixing chamber, situated downstream of the exchangers, between various air ducts opening into various zones of the cabin, in particular the zone of the windshield for defrosting, the central zone of the dashboard for ventilating the cabin and the front passengers' feet zone of the vehicle, each air duct being able to be closed or opened by a flap actuated by a lever.

It is well known that these heating, ventilation and/or air-conditioning units of motor vehicles, termed by the acronym HVAC, commonly make use of cams to move one or more levers in a synchronized manner and/or to follow a particular movement law in order to open and close an air duct via shutters or flaps of the distribution means.

These cams are coupled to a rotary shaft able to execute a back-and-forth rotational movement corresponding to the desired alternating movement of opening and closing said shutters or flaps. The rotary shaft of the cam can be actuated by means of an electric motor, or else manually via a cable.

Said cams comprise a perimetric camway defined between an outer wall and an inner wall, the camway departing to a greater or lesser extent from the rotary shaft between its two distal ends. It is in this way possible to modify the positioning of cam followers capable of sliding in the camway.

Such a cam-operated device is described in particular in document FR 2 335 753. The latter has an operating device for a transmission member such as a pull cable or linkage, in motor vehicles, which is articulated on a rotationally supported lever having a journal engaged in a camway made in a rotatable cam. Said cam has a disk shape and comprises a camway in the form of a spiral on each of these faces. The camways are arranged in an inverted manner in the thickness of the cam.

Although advantageous since they enable a plurality of cam followers to be guided by way of their different faces, this type of cam-operated device has a significant bulk in the direction of the rotary shaft of the cam.

The invention aims to improve the situation by proposing a cam-operated device for controlling at least one component, said device comprising a cam comprising at least one first camway on a first face and one second camway on an opposite face, said first camway having a depth, measured from an opening, at the level of said first face, of said first camway, and said second camway having a depth, measured from an opening, at the level of said opposite face, of said second camway, a height of the cam between the opening of the first and second camways being less than the sum of the depths of the camways.

The cam-operated device according to the invention in this way provides an interpenetration of the camways of the opposite faces of the cam, thereby making it possible to significantly reduce the thickness of the cam and, therefore, its bulk.

According to various embodiments of the invention, considered together or separately:
each camway has a rectangular or square cross section,
at least one of the camways of the first face of the cam is secant with at least one of the camways of the opposite face of said cam, said camways being referred to as interrupted,
the interrupted camway(s) of the first face of the cam open onto the interrupted camway(s) of the opposite face of said cam over a height which is less than the depth of said interrupted camway(s) of the opposite face of said cam,
the cam comprises a central rotary shaft,
the cam has a disk shape,
each camway has a different depth.

The invention also relates to a system for operating at least one movable part, said system comprising a cam-operated device as mentioned above.

According to various embodiments, said system may have the following additional features, considered together or separately:
said system comprises at least one lever driven by the movement of the cam and one of whose ends comprises a follower roller able to slide in one of said camways, said lever being configured to actuate said movable part,
said follower roller has a height which is less than the depth of the corresponding camway,
the follower roller bears locally on an inner wall of the camway over a depth which is less than or equal to 50%, or even ⅕, of the depth of said camway.

The invention additionally relates to a heating, ventilation and/or air-conditioning installation comprising an operating system as described above. Advantageously, said movable part is a flap of said installation, in particular a distribution flap.

However, this application of the invention is not limiting and it goes without saying that the cam-operated device according to the invention will find numerous applications, whether the cam is rotatable or translatable, without thereby departing from the scope of the invention.

The invention will be better understood in the light of the following description which is given merely by way of indication and which is not aimed at limiting it, accompanied by the appended drawings, in which:

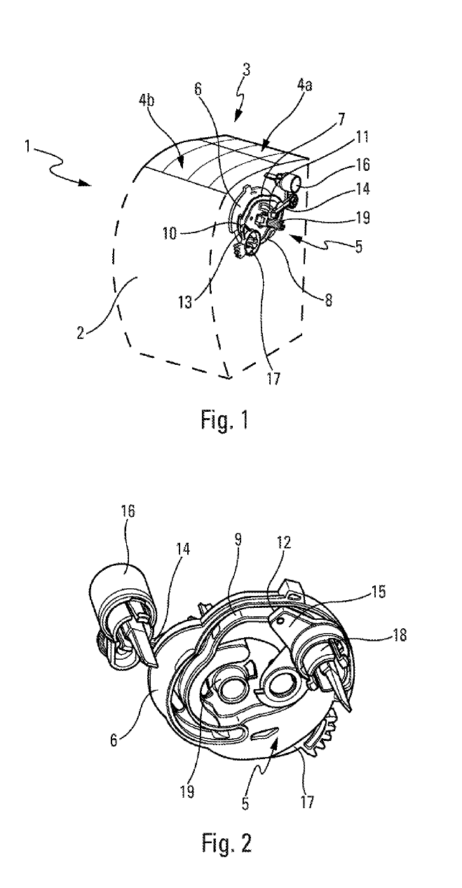

FIG. 1 is a perspective view of the cam-operated device according to the invention for operating distribution flaps of a heating, ventilation and/or air-conditioning unit of a motor vehicle,

FIG. 2 is a bottom perspective view of the cam-operated device according to the invention, provided with levers for controlling the flaps,

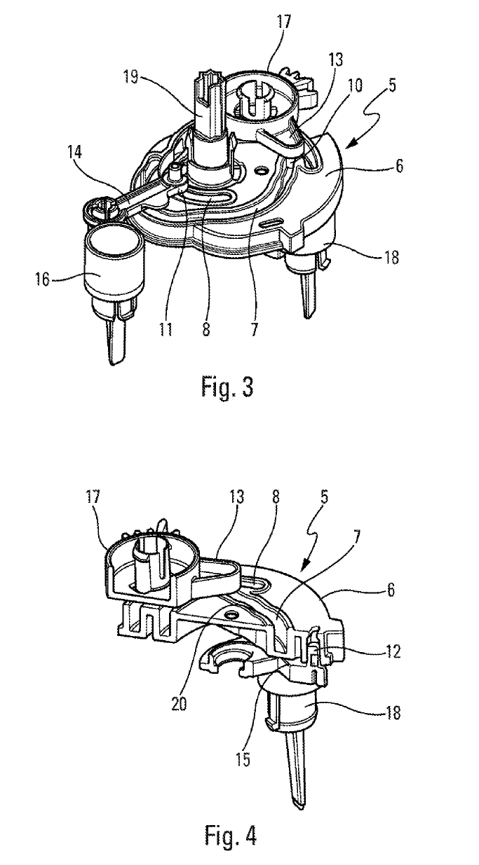

FIG. 3 is a top perspective view of the cam-operated device according to the invention, provided with the levers for controlling the flaps,

FIG. 4 is a perspective view of a radial section of the cam-operated device according to the invention, provided with the levers for controlling the flaps,

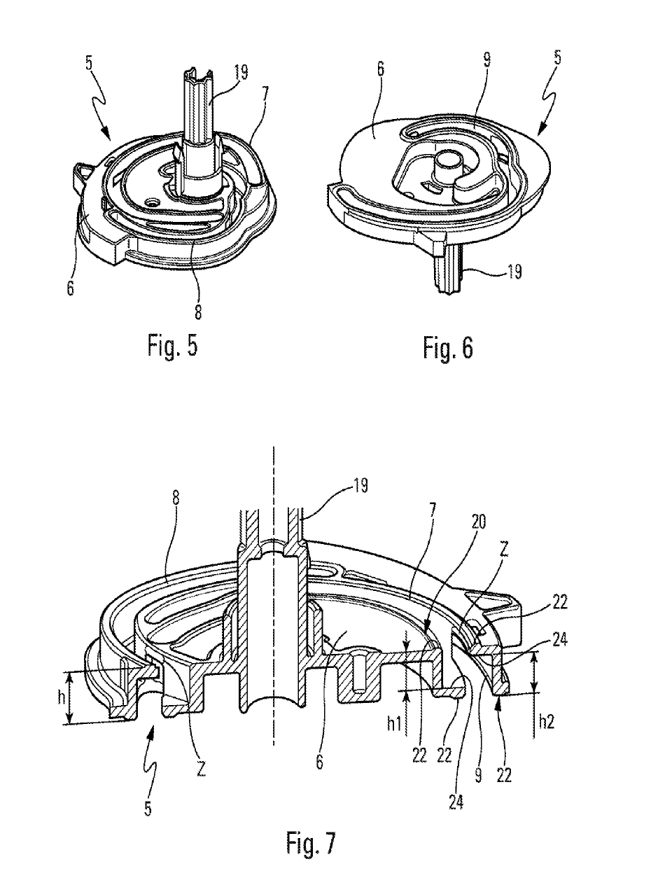

FIG. 5 is another top perspective view of the cam-operated device according to the invention, without the levers for controlling the flaps,

FIG. 6 is another bottom perspective view of the cam-operated device according to the invention, without the levers for controlling the flaps,

FIG. 7 is another perspective view of a radial section of the cam-operated device according to the invention, without the levers for controlling the flaps.

With reference to FIG. 1, the cam-operated device according to the invention is integrated, in this particular example, into a device for controlling a heating, ventilation and/or air-conditioning unit 1 of motor vehicles, termed HVAC, intended to be situated in the front part of the cabin of a vehicle, not depicted in the figure, and housed below a dashboard of the vehicle, likewise not depicted.

Said heating, ventilation and/or air-conditioning unit 1 comprises a heat treatment housing 2. Only an upper face of said housing 2 has been illustrated, the remainder of the housing having been only depicted, in dashed lines, by its contour.

Said housing 2 comprises various components for the heat treatment of the air flow, such as an evaporator and/or a radiator, which are not visible, intended for the heat treatment of the air flow, in particular by allowing cooling thereof and/or dehumidifying thereof and/or heating thereof, and aeraulic management means 3 making it possible to channel the air flow and to distribute it into various zones of the cabin, such as the windshield zone, the feet zone and the central zone.

To this end, the aeraulic management means 3 comprise a plurality of outlets connected to conduits respectively supplying the windshield zone, outlet 4a, the feet zone, outlet not illustrated, and the central zone, outlet 4c. Said outlets are provided with flaps, not depicted in FIG. 1, controlled by a cam-operated device 5.

With reference to FIGS. 1 to 4, the cam-operated device 5 is constituted by a cam 6 here having a general disk shape and provided on a first of its faces, in this instance its outer face, with two camways 7 and 8 and, on its opposite face, that is to say its face which faces the heat treatment housing 2, with a camway 9. Said cam is formed, for example, by molding, in particular from a plastics material.

Each camway 7, 8 and 9 receives a follower roller 10, 11 and 12, respectively, secured to one of the ends of a lever 13, 14 and 15, respectively, the opposite end of each lever being secured to an actuating member 16, and 18, respectively, for actuating a flap of the aeraulic management means 3, this being achieved via possible deflection members.

It goes without saying that the follower rollers 10, 11 and 12, respectively, may be replaced by any other equivalent means well known to a person skilled in the art without thereby departing from the scope of the invention.

Said cam 6 comprises in its central part a rotary shaft 19 to ensure that said cam can be rotated with respect to the heat treatment housing 2. The rotation of the cam about its axis of rotation, which is embodied by the rotary shaft 19, determines its angular position and, therefore, the position of the follower rollers 10, 11, 12 along their respective camway 7, 8 and 9. The camways 7, 8 and 9 have a path which allows the follower rollers 10, 11, 12 to depart to a greater or lesser extent from the rotary shaft 19. They act in this way on the positioning of the flaps to which they are connected.

With reference to FIGS. 4 and 7, each camway 7, 8 and has a substantially rectangular or square cross section and a depth h1 and h2 which is only just less than the height h of the disk forming the cam 6. Thus, the height h of the cam 6 is less than the sum of the depths (h1+h2) of the camways 7, 8 and 9 of the two opposite faces of said cam 6, the height h being measured between the opening of the camways 7, 8 and 9 on the face at which they open out. In other words, the camways 7, 8 and 9 are imbricated in the thickness of the cam rather than one being situated in a first axial half of the thickness of the cam and the other being situated in the other axial half of the thickness of the cam.

Here, the faces of the cam have a lip 20 bordering the camways 7, 8 and 9, and the opening of the camways is considered to be situated at an upper edge 22 of this lip 20 such that the depth of the cams is measured between said upper edge 22 and a bottom 24, provided to be flat, of the camway. As for the thickness of the cam, it is measured between the upper edge 22 of the lips of the camways situated on each of the opposite faces of the cam.

In a variant, the lip may not be present and the depth of the camways will then be measured from the general surface of extension of the corresponding faces of the cam. Likewise, the thickness of the cam will be measured between the general surfaces of extension of the opposite faces of the cam. In another variant, the bottom of the cam may not be flat and the depth of the cam will then be measured, for example, with respect to the deepest point. It will be noted that the depths h1 and h2 of the camways 7, 8 and 9 may be equal or different.

The follower rollers 10, 11 and 12 bear on one or other of the lateral walls of the camways, termed inner wall of the camway 7, 8 and 9, over a depth which is less than the depth h1 or h2 of said camway 7, 8 and 9. Preferably, the bearing depth of the follower rollers 10, 11 and 12 is between 1 and 5 mm. It extends from the opening of the camways 7, 8 and 9 in the direction of the bottom thereof.

With reference to FIGS. 5 to 7, the camways 7, 8 of the outer face of the cam 6 open onto the camway 9 of the opposite face of said cam 6 over a height which is less than the depth h1, h2 of the camways. In other words, the camway(s) of one of the faces may intersect the camway(s) of the opposite face. Said camways 7, 8 here have in this way, locally, apertures for the passage of the follower roller of the camway 9 of the opposite face of the cam, and conversely, said apertures being situated at their inner walls. To avoid any blockage, the angular position of the follower rollers will be provided so that two follower rollers are not simultaneously situated at the same time at an intersection.

Preferably, at said intersections, the camway(s) open onto one another over a height which is less than their depth such that there remains a bearing depth fraction Z for the follower rollers at their inner face. Said depth fraction Z extends from the opening of the camways 7, 8 and 9, for example over a height which is less than 50%, or even 1/50 of the depth of said camways 7, 8 and 9.

Said cam may additionally comprise one or more wells for the articulation of various shafts, in particular articulation shafts for the actuating members.

It is quite clear that the cam-operated device according to the invention may comprise a cam guided in translation and not in rotation without thereby departing from the scope of the invention.

Finally, it is quite clear that the cam-operated device according to the invention may be adapted to all types of control of a component and also to all types of component. Likewise, the exemplary embodiments given above are only particular illustrations which are in no case limiting as to the fields of application of the invention.

1. A cam-operated device for controlling at least one component, said cam-operated device comprising:
a cam comprising at least one first camway on a first face and a second camway on an opposite face to the first face,
said first camway having a depth measured from an opening at a level of said first face, of said first camway, and
said second camway having a depth measured from an opening at a level of said opposite face, of said second camway,
a height of the cam being measured between the openings of the first and second camways, the height being less than a sum of the depths of the first and second camways.

2. The cam-operated device as claimed in claim 1, in which each camway has a rectangular or square cross section.

3. The cam-operated device as claimed in claim 1, wherein at least one of the caraways of the first face of the cam is secant with at least one of the caraways of the opposite face of said cam, said camways being referred to as interrupted.

4. The cam-operated device as claimed in claim 3, wherein the interrupted camway(s) of the first face of the cam open onto the interrupted camway(s) of the opposite face of said cam over a height which is less than the depth of the interrupted camway(s) of the opposite face of said cam.

5. The cam-operated device as claimed in claim 14, in which the cam comprises a central rotary shaft.

6. The cam-operated device as claimed in claim 5, in which the cam has a disk shape.

7. The cam-operated device as claimed in claim 1, wherein each camway has a different depth.

8. A system for operating at least one movable part, said system comprising:
a cam-operated device as claimed in claim 1; and
at least one lever driven by the movement of the cam, wherein one end of the at least one lever comprises a follower roller able to slide in one of said caraways, said lever being configured to actuate said movable part.

9. The operating system as claimed in claim 8, in which said follower roller has a height which is less than the depth of the corresponding camway.

10. The operating system as claimed in claim 8, in which the follower roller bears locally on an inner wall of the caraway over a depth which is less than or equal to ⅕ of the depth of said camway.

11. A heating, ventilation and/or air-conditioning installation comprising an operating system as claimed in claim 8.

12. The installation as claimed in claim 11, in which said movable part is a distribution flap of said installation.
